(19) United States
(12) Patent Application Publication
(10) Pub. No.: US 2026/0063956 A1
(43) Pub. Date: Mar. 5, 2026

(54) LIQUID CRYSTAL DISPLAY PANEL

(71) Applicant: TCL China Star Optoelectronics Technology Co., Ltd., Shenzhen (CN)

(72) Inventors: Hongyuan LI, Shenzhen (CN); Jingwen ZHUANG, Shenzhen (CN); Xiaohui YAO, Shenzhen (CN)

(73) Assignee: TCL China Star Optoelectronics Technology Co., Ltd., Shenzhen (CN)

(21) Appl. No.: 18/929,756

(22) Filed: Oct. 29, 2024

(30) Foreign Application Priority Data
Sep. 5, 2024 (CN) 202411241202.5

(51) Int. Cl. G02F 1/1362; G02F 1/1368

(52) U.S. Cl. CPC G02F 1/13629; G02F 1/1368

(57) ABSTRACT

A liquid crystal display panel includes an array substrate and the array substrate includes: cascaded gate driver modules in the gate driver circuit area, the gate driver modules each including a first thin film transistor, the first thin film transistor including a first electrode and a second electrode, each first electrode being connected to a scan line located in the display area, and each second electrode being connected to a clock signal line; and a plurality of first spacers disposed in the gate driver circuit area. In a plan view of the liquid crystal display panel, the gate driver modules are arranged at intervals along a first direction, the first thin film transistors are arranged at intervals along the first direction, and the first spacers are located outside the second electrodes.

### CROSS-REFERENCE TO RELATED APPLICATION

This application claims the benefit of priority of Chinese Patent Application No. 202411241202.5, filed on Sep. 5, 2024, the contents of which are incorporated by reference as if fully set forth herein in their entirety.

### TECHNICAL FIELD

The present application relates to the field of optoelectronic technologies, and in particular to a liquid crystal display panel.

### BACKGROUND

Due to the limitation of sizes of photomasks, the photomasks need to be arranged in a splicing manner for exposure, so as to meet the requirements of production of large-sized liquid crystal display panels. The process of manufacturing photo spacers (PS, or spacers) in the array substrate requires, taking a 98-inch display panel as an example, 5 shots/Pcs if adopting the traditional mosaic splicing, which means that each array substrate needs to undergo 5 exposures. However, the number of exposures may be reduced to 2 by adopting a direct splicing manner. Direct splicing of PS refers to the manner in which spacers are formed in the entire panel by direct splicing at the edges of the display area.

### SUMMARY

Embodiments of the present application provide a display panel, which reduces the risk of damage to the first thin film transistors in the gate driver circuit area.

In a first aspect, embodiments of the present application provide a liquid crystal display panel, which includes an array substrate and a counter substrate that are arranged opposite to each other, the liquid crystal display panel having a display area and a gate driver circuit area, the gate driver circuit area being located at at least one side of the display area, the array substrate including:
a plurality of gate driver modules that are cascaded in the gate driver circuit area, the gate driver modules each including a first thin film transistor, and the first thin film transistor including a first electrodes and a second electrode, the first electrode being connected to a scan line located in the display area, and the second electrode being connected to a clock signal line; and
a plurality of first spacers disposed in the gate driver circuit area.

In a plan view of the liquid crystal display panel, the plurality of gate driver modules are arranged at intervals along a first direction, all the first thin film transistors are arranged at intervals along the first direction, and the first spacers are located outside all the second electrodes.

Optionally, in the plan view of the liquid crystal display panel, each of the first spacers is disposed in an adjacent area of two adjacent ones of the first thin film transistors in the first direction.

Optionally, the first electrode includes an output bus connected to the scan line and output branches connected to the output bus, and the second electrode includes an input bus connected to the clock signal line and input branches connected to the input bus.

In the plan view of the liquid crystal display panel, the output branches and the input branches are alternately arranged at intervals along a second direction intersecting the first direction, the first spacer is located outside all the output branches of the two adjacent first thin film transistors, at least a portion of the first spacer overlaps with the output bus of one of the two adjacent first thin film transistors.

Optionally, in the plan view of the liquid crystal display panel, in the adjacent area of the two adjacent first thin film transistors, the first spacer is located outside the other of the two adjacent first thin film transistors.

Optionally, the one of the two adjacent first thin film transistors further includes a gate, the gate also serves as a first electrode plate of a capacitor, the output bus also serves as a second electrode plate of the capacitor, and the gate overlaps with the output bus to form the capacitor.

In the plan view of the liquid crystal display panel, the first spacer entirely overlaps with the capacitor.

Optionally, the liquid crystal display panel includes a peripheral area located at a side of the gate driver circuit area away from the display area, the clock signal line includes a clock signal main line and clock signal branches connected to the clock signal main line, the clock signal main line is located in the peripheral area, each of the clock signal branches extends from the peripheral area to the gate driver circuit area and is connected to the second electrode of the first thin film transistor of a corresponding one of the gate driver modules, the array substrate further includes a plurality of second spacers located at a side of the first spacers away from the display area.

In the plan view of the liquid crystal display panel, the plurality of second spacers are located at a side of the clock signal main line close to the display area and outside the clock signal branches.

Optionally, along the first direction, a width of each of the clock signal branches is less than a width of each of the plurality of second spacers.

Optionally, the gate driver module further includes a second thin film transistor to a twenty-third thin film transistor, and in the plan view of the liquid crystal display panel, the plurality of second spacers are located outside the second thin film transistor to the twenty-third thin film transistor.

Optionally, the array substrate further includes a low-frequency clock signal line and a first low-level power line that are located in the peripheral area, the first low-level power line is located at a side of the low-frequency clock signal line away from the clock signal main line.

In the plan view of the liquid crystal display panel, the plurality of second spacers are located at the side of the low-frequency clock signal line away from the clock signal line.

The plurality of second spacers are arranged in rows along the second direction, and part of the second spacers in one of the rows overlaps with the first low-level power line.

Optionally, the array substrate includes: a first base, a first metal layer, a first insulating layer, a second metal layer, a second insulating layer, a color resist layer, and a third insulating layer that are arranged in sequence, the color resist layer is disposed in the display area, the first spacers and the second spacers are disposed on a side of the third insulating layer away from the first base.

The second metal layer includes a plurality of wires arranged at intervals, and each of the second spacers overlaps with at most one of the wires.

Optionally, the liquid crystal display panel further includes an adhesive frame disposed between the array substrate and the counter substrate, the adhesive frame is correspondingly disposed in the peripheral area, and the adhesive frame is located at a side of the clock signal main line away from the display area.

A distance between one of the second spacers closest to the adhesive frame in the second direction and the adhesive frame is less than 2700 micrometers.

Optionally, the first spacers and the second spacers are arranged along the second direction, and in the plan view of the liquid crystal display panel, the first spacers and the second spacers are each disposed between two adjacent ones of the gate driver modules.

Optionally, the array substrate further includes third spacers disposed in the display area, the second spacers, the first spacers, and the third spacers are arranged along the second direction.

In the liquid crystal display panel of the present application, since the first spacers are disposed outside the second electrodes of the first thin film transistors, the effect of the stress of the first spacers on film layers in the area where the second electrodes are located is reduced, thereby reducing the risk of metal precipitating from the second electrodes, and thus reducing the risk of damage to the first thin film transistors.

### BRIEF DESCRIPTION OF THE DRAWINGS

In order to describe the technical solutions in the embodiments of the present application more clearly, accompanying drawings to be used in the description of the embodiments of the present application will be briefly introduced below. Obviously, the accompanying drawings to be described below are merely accompanying drawings of some embodiments of the present application. For those of ordinary skill in the art, other drawings can be obtained based on the content of the embodiments and these drawings of the utility model without creative efforts.

In order to fully understand the present application and beneficial effects thereof, the description will be given below in conjunction with the drawings, and the same reference numbers in the description below indicate the same parts in the drawings.

FIG. 1 is a partial structural schematic diagram of a large-sized liquid crystal display panel in the related art;

FIG. 2 is a sectional view of a liquid crystal display panel provided in embodiments of the present disclosure;

FIG. 3 is a plan view of a liquid crystal display panel provided in embodiments of the present disclosure;

FIG. 4 is an enlarged view of the part A in FIG. 3;

FIG. 5 is an enlarged view of the part B in FIG. 4;

FIG. 6 is an enlarged view of the part C in FIG. 4; and

FIG. 7 is an equivalent circuit diagram of a gate driver module of a liquid crystal display panel provided in embodiments of the present disclosure.

### DETAILED DESCRIPTION

The technical solutions in the embodiments of the present application will be described clearly and completely below in conjunction with the accompanying drawings in the embodiments of the present application, and it is obvious that the described embodiments are only a part of the embodiments of the present application, and not all of the embodiments. Based on the embodiments in the present application, all other embodiments obtained by those skilled in the art without creative efforts fall within the scope of protection of the present application. In addition, it will be understood that, the specific implementations described herein are only for the purpose of illustrating and explaining the present application and do not limit the present application. In the present application, various embodiments may be combined with each other without further elaboration, and in the absence of any indication to the contrary, the terms “upper” and “lower” are generally used to refer to the upper and lower direction of the device in the actual use or working state, specifically the direction of the drawing in the accompanying drawings; the terms “inner” and “outer” are used with respective to the contour of the device; and the terms such as “first”, “second” and “third” are used only as indications and do not impose numerical requirements or establish an order.

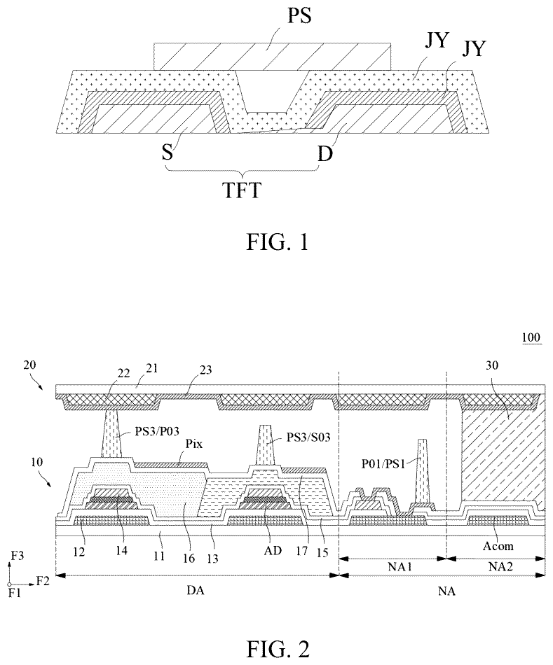

It will be noted that, a gate driver circuit in a large-sized liquid crystal display panel includes a plurality of gate driver modules that are cascaded, and one of the gate driver modules is connected to a corresponding scan line. The gate driver modules each include an output thin film transistor, an output terminal of the output thin film transistor is connected to the scan line, and an input terminal of the output thin film transistor is connected to a clock signal line. In the process of manufacturing the spacers, the PS direct splicing manner is generally used to prepare the spacers. However, the inventor(s) have found that, as shown in FIG. 1, spacers PS in the display area are located, after the process of repeated exposure in direct splicing of PS, in the middle area of thin film transistors TFT in the gate driver circuit area and the spacers PS each cover a source S and a drain D of a thin film transistor TFT. The stress of the spacers PS deteriorates under the long-term action of moisture and temperature, leading to the separation of insulating layers JY under the spacers, which in turn causes the metal of sources S and drains D under the spacers to precipitate, thereby leading to damage (transistors failure) when electricity is applied to the sources S and drains D.

In a liquid crystal display panel provided in embodiments of the present application, first spacers are disposed outside second electrodes of the first thin film transistors (equivalent to the output thin film transistors mentioned above), the effect of the stress of the first spacers on the film layers in the area where the second electrodes are located is reduced, thereby reducing the risk of metal precipitating from the second electrodes, and thus reducing the risk of damage to the first thin film transistors.

Embodiments of the present application provide the liquid crystal display panel, which will be described in detail below. It will be noted that the order of description of the following embodiments does not limit the preferred order of the embodiments.

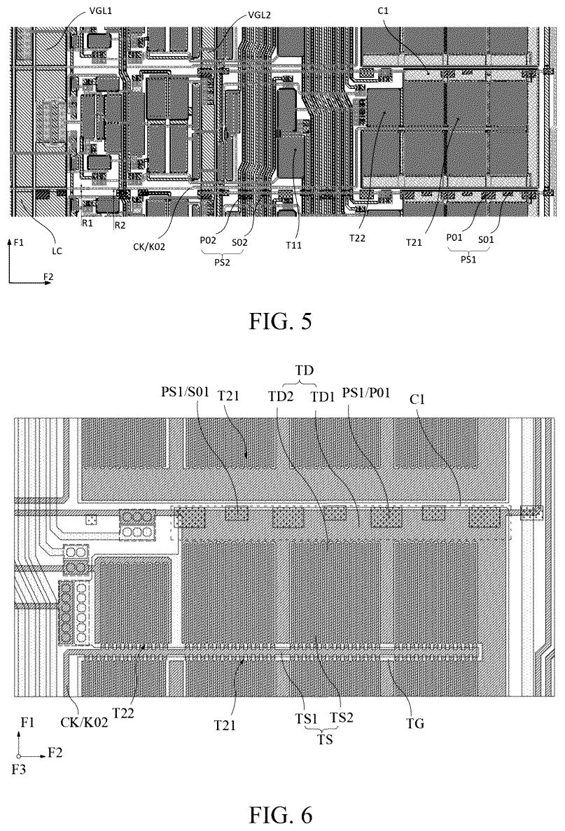

Referring to FIGS. 2 to 6, the first direction F1 may be a direction parallel to a side of the liquid crystal display panel 100 in a plan view of the liquid crystal display panel 100. For example, the first direction F1 may be a longitudinal direction of the liquid crystal display panel 100. The second direction F2 may be a direction parallel to another side (not opposite to the above-mentioned side) of the liquid crystal display panel 100 in the plan view, and may be a transverse direction of the liquid crystal display panel 100. The third direction F3 may be a thickness direction of the liquid crystal display panel 100. Optionally, the first direction F1 may also intersect the second direction F2 non-perpendicularly.

The liquid crystal display panel 100 may include a display area DA and a non-display area NA. In the plan view, the shape of the display area DA may correspond to the shape of the liquid crystal display panel 100. For example, in a case where the liquid crystal display panel 100 has a rectangular shape in the plan view, the display area DA may also have a rectangular shape.

The display area DA may be an area having pixels for displaying images. The pixels may be arranged in a matrix form. Each of the pixels may have a rectangular shape, a rhombic shape, or a square shape in the plan view, which is not limited in the embodiments. For example, each pixel may have other quadrilateral shape than the rectangular shape, the rhombic shape, and the square shape, other polygon shape, a circular shape, or an elliptical shape in the plan view.

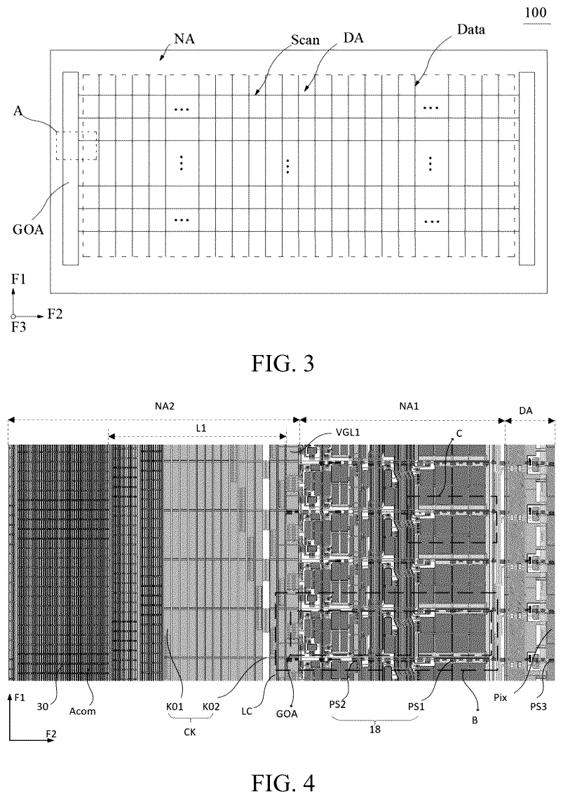

The non-display area NA may be an area by which no image is displayed. The non-display area NA may be arranged at the vicinity (or periphery) of the display area DA. As shown in FIG. 3, the non-display area NDA may surround the display area DA, which is not limited in the embodiments.

The non-display area NA may include a gate driver circuit area NA1 and a peripheral area NA2. The gate driver circuit area NA1 is located at at least one side of the display area DA. For example, the gate driver circuit area NA1 may be located at one side of the display area DA, or the gate driver circuit area NA1 may be located at opposite sides of the display area DA.

Optionally, the liquid crystal display panel 100 in one or more embodiments of the present application includes an array substrate 10 and a counter substrate 20 that are arranged opposite to each other. Liquid crystals (not shown in the figures) are provided between the array substrate 10 and the counter substrate 20.

As shown in FIG. 2, an adhesive frame 30 is provided between the array substrate 10 and the counter substrate 20. The adhesive frame 30 is used to encapsulate the liquid crystals and connect the array substrate 10 and the counter substrate 20.

Optionally, the architecture for driving the liquid crystals in the liquid crystal display panel 100 may be a driving architecture based on Vertical Alignment (VA) technologies, which is not limited. For example, the architecture for driving the liquid crystals may also be a driving architecture based on Fringe Field Switching (FFS) technologies, or a driving architecture based on In-Plane Switching (IPS) technologies, or a driving architecture based on TN technologies. The description will be given below by taking an example in which the liquid crystal display panel 100 has the VA driving architecture, which is not limited.

Optionally, the counter substrate 20 includes: a second base 21, a black matrix layer 22, and a common electrode layer 23 that are disposed in sequence. The common electrode layer 23 is disposed on a side of the black matrix layer 22 close to the array substrate 10.

In some embodiments, the array substrate 10 includes: a first base 11, a first metal layer 12, a first insulating layer 13, a second metal layer 14, a second insulating layer 15, a color resist layer 16, a third insulating layer 17 and spacers 18 that are disposed in sequence. The color resist layer 16 is disposed in the display area DA.

It will be understood that, the color resist layer 16 shown in FIG. 2 is disposed in the array substrate 10, which is not limited. For example, the color resist layer 16 may also be disposed in the counter substrate 20.

Optionally, the first metal layer 12 includes various signal lines, such as scan lines Scan, at least portions of clock signal lines CK, at least portions of low-frequency clock signal lines LC, at least portions of common electrode lines Acom, at least portions of low-level power lines, gates of thin film transistors, and other wire(s).

Referring to FIGS. 3 to 6, the second metal layer 14 includes various signal lines, such as data lines Data, at least portions of the clock signal lines CK, at least portions of the low-frequency clock signal lines LC, at least portions of the low-level power lines, first electrodes and second electrodes of the thin film transistors, and other wire(s).

The array substrate 10 further includes an active layer AD disposed on the first insulating layer 13. The first electrodes and the second electrodes of the thin film transistors are both connected to the active layer AD.

The array substrate 10 further includes pixel electrodes Pix disposed in the display area DA and on a side of the third insulating layer 17 away from the first base 11. The common electrode layer 23 and the pixel electrodes Pix are used such that an electric field is generated to drive the liquid crystals to deflect.

Optionally, the spacers 18 are used to support the array substrate 10 and the counter substrate 20 and to define the thickness of the liquid crystal cell. The spacers 18 avoid the pixel electrodes Pix. The spacers 18 include: first spacers PS1, second spacers PS2, and third spacers PS3, the first spacers PS1 and the second spacers PS2 are disposed in the non-display area NA, and the third spacers PS3 are disposed in the display area DA.

Referring to FIGS. 3 to 6, optionally, the first spacers PS1 are disposed in the gate driver circuit area NA1, and at least part of the second spacers PS2 are disposed in the gate driver circuit area NA1. For example, part of the second spacers PS2 are disposed in the gate driver circuit area NA1, and other part of the second spacers PS2 are disposed in the peripheral area NA2. Alternatively, all the second spacers PS2 are disposed in the gate driver circuit area NA1.

It will be understood that, since the color resist layer 16 is not disposed in the non-display area NA, with respect to the first base 11, the height of the third spacers PS3 is the highest, and the heights of the first spacers PS1 and the second spacers PS2 are lower.

In some embodiments, the first spacers PS1 are arranged between the second spacers PS2 and the third spacers PS3 in the second direction F2. That is, the second spacers PS2, the first spacers PS1, and the third spacers PS3 are arranged along the second direction F2.

The first spacers PS1 to the third spacers PS3 may be formed by adopting the PS direct splicing manner, such that the second spacers PS2, the first spacers PS1, and the third spacers PS3 are arranged along the second direction F2, and thus the exposure time is reduced.

In addition, each of the first spacers PS1 includes a first main spacer P01 and a first auxiliary spacer S01, the thickness of the first main spacer P01 is greater than the thickness of the first auxiliary spacer S01, and the area of the plan view pattern of the first main spacer P01 is greater than the area of the plan view pattern of the first auxiliary spacer S01. Each of the second spacers PS2 includes a second main spacer P02 and a second auxiliary spacer S02, the thickness of the second main spacer P02 is greater than the thickness of the second auxiliary spacer S02, and the area of the plan view pattern of the second main spacer P02 is greater than the area of the plan view pattern of the second auxiliary spacer S02. Each of the third spacers PS3 includes a third main spacer P03 and a third auxiliary spacer S03, the thickness of the third main spacer P03 is greater than the thickness of the third auxiliary spacer S03, and the area of the plan view pattern of the third main spacer P03 is greater than the area of the plan view pattern of the third auxiliary spacer S03.

Optionally, the thicknesses of the first main spacer P01, the second main spacer P02, and the third main spacer P03 may be equal to each other, which is not limited. For example, the thicknesses may also be unequal. The areas of the plan view patterns of the first main spacer P01, the second main spacer P02, and the third main spacer P03 may be equal to each other, which is not limited. For example, the areas may also be unequal.

The thicknesses of the first auxiliary spacer S01, the second auxiliary spacer S02, and the third auxiliary spacer S03 may be equal to each other, which is not limited thereto. For example, the thicknesses may also be unequal. The areas of the plan view patterns of the first auxiliary spacer S01, the second auxiliary spacer S02, and the third auxiliary spacer S03 may be equal to each other, which is not limited. For example, the areas may also be unequal.

In some embodiments, the thicknesses of the first main spacer P01 and the second main spacer P02 are greater than the thickness of the third main spacer P03.

It will be understood that, with respect to the first base 11, the heights of the first main spacer P01 and the second main spacer P02 are lower than the height of the third main spacer P03, so that when the panel is pressed by an external force, there will be a risk of damage happening to the array substrate 10 and the counter substrate 20 in the non-display area NA if the distance between the array substrate 10 and the counter substrate 20 in the non-display area NA becomes relatively small. Therefore, the thicknesses of the first main spacer P01 and the second main spacer P02 are arranged to be greater than the thickness of the third main spacer P03, therefore, the heights of the first main spacer P01 and the second main spacer P02 are increased, thereby reducing the risk of damage to the array substrate 10 and the counter substrate 20 in the non-display area NA.

In some embodiments of the present application, the first spacers PS1 and the second spacers PS2 are disposed at the side of the third insulating layer 17 away from the first base 11. The second metal layer 14 includes a plurality of wires arranged at intervals, and each of the second spacers PS2 partially overlaps with at most one of the wires in the second metal layer 14.

It will be noted that, the second metal layer 14 is closer to the spacers 18 than the first metal layer 12 to the spacers 18, and thus the second metal layer 14 is more affected by the stress of the spacers 18. Therefore, the second spacers PS2 are configured to stand without spanning across wires, which may reduce the complexity of the structures under the second spacers PS2, thereby reducing the risk of stress concentration in the insulating layers under the second spacers PS2, and further reducing the risk of metal precipitating from the wirings. In addition, the second spacers PS2 directly affect only one wire, which greatly reduces the risk of metal precipitating from adjacent wires, thereby reducing the risk of damage to the wires.

Referring to FIGS. 3 to 4, in some embodiments, the array substrate 10 includes a plurality of gate driver modules GOA that are cascaded. The plurality of gate driver modules GOA are disposed in the gate driver circuit area NA1, and each of the gate driver modules GOA is used to provide a gate signal to one scan line Scan.

The gate driver module GOA includes a plurality of thin film transistors. The plurality of thin film transistors are N-type thin film transistors, which is not limited. For example, at least one of the plurality of thin film transistors is a P-type thin film transistor. The thin film transistors may be of bottom-gate type, which is not limited. For example, the thin film transistors may also be of top-gate type, dual-gate type, or vertical type.

In addition, the sources and the drains may be interchanged based on different types of thin film transistors. For example, the input terminal of the N-type thin film transistor is the source, and the output terminal of the N-type thin film transistor is the drain; the input terminal of the P-type thin film transistor is the drain, and the output terminal of the P-type thin film transistor is the source.

It will be noted that, an Nth cascade signal line ST(N) may be used to transmit an Nth cascade signal, and an Nth scan line G(N) is used to transmit an Nth scan signal; the low-level power line VGL is used to transmit a low potential signal; an (N+Y)th scan line G(N+Y) is used to transmit an (N+Y)th scan signal, and an (N+Y)th cascade signal line is used to transmit an (N+Y)th cascade signal; and an (N−X)th scan line G(N−X) is used to transmit an (N−X)th scan signal, and an (N−X)th cascade signal line is used to transmit an (N−X)th cascade signal, where X, Y, N are positive integers.

Optionally, the gate driver modules GOA may be of any circuit architecture, as long as the gate driver modules GOA can drive the panel to perform display. The description will be given below by taking an example in which the gate driver modules GOA each include a first thin film transistor T21 to a twenty-third thin film transistor T73 and a capacitor C1, which is not limited.

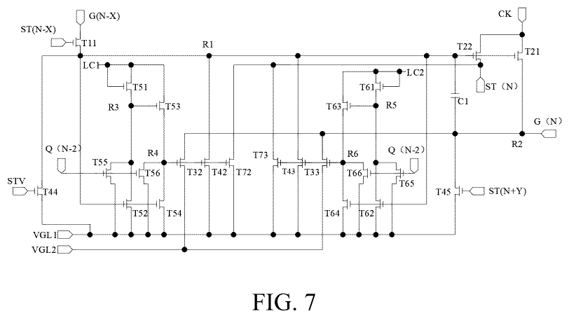

Referring to FIG. 7, the gate driver module GOA includes a pull-up module, a pull-up control module, a first pull-down maintenance module, a second pull-down maintenance module, and a pull-down module.

The pull-up module includes the first thin film transistor T21, the second thin film transistor T22, and the capacitor C1. A gate of the first thin film transistor T21 is connected to a first node R1, a source (the second electrode TS) of the first thin film transistor T21 is connected to the clock signal line CK, and a drain (the first electrode TD) of the first thin film transistor T21 is connected to a second node R2. The second node R2 is connected to the scan line Scan. A gate of the second thin film transistor T22 is connected to the first node R1, a source of the second thin film transistor T22 is connected to the clock signal line CK, and a drain of the second thin film transistor T22 is connected to the Nth cascade signal line ST(N). A first electrode plate of the capacitor C1 is connected to the first node R1, and a second electrode plate of the capacitor C1 is connected to the second node R2.

The pull-up control module includes the third thin film transistor T11. A gate of the third thin film transistor T11 is electrically connected to the (N−X)th cascade signal line ST(N−X), a source of the third thin film transistor T11 is electrically connected to the (N−X)th scan signal line G(N−X), and a drain of the third thin film transistor T11 is electrically connected to the first node R1 and the pull-down maintenance module.

A gate of the fourth thin film transistor T44 is connected to a reset control signal line STV which transmits a reset control signal, a source of the fourth thin film transistor T44 is connected to the first node R1, and a drain of the fourth thin film transistor T44 is connected to a first low-level power line VGL1.

The pull-down module includes the fifth thin film transistor T45. A gate of the fifth thin film transistor T45 is connected to the (N+Y)th cascade signal line ST(N+Y), a source of the fifth thin film transistor T45 is connected to the second node R2, and a drain of the fifth thin film transistor T45 is connected to the first low-level power line VGL1.

The first pull-down maintenance module includes the sixth thin film transistor T51 to the fourteenth thin film transistor T72. A gate and a drain of the sixth thin film transistor T51 are connected to a first low-frequency clock signal line LC1, and a source of the sixth thin film transistor T51 is connected to a third node R3. A gate of the seventh thin film transistor T52 is connected to the first node R1, a drain of the seventh thin film transistor T52 is connected to the third node R3, and a source of the seventh thin film transistor T52 is connected to the first low-level power line VGL1. A gate of the eighth thin film transistor T53 is connected to the third node R3, a drain of the eighth thin film transistor T53 is connected to the first low-frequency clock signal LC1, and a source of the eighth thin film transistor T53 is connected to a fourth node R4. A gate of the ninth thin film transistor T54 is connected to the first node R1, a drain of the ninth thin film transistor T54 is connected to the fourth node R4, and a source of the ninth thin film transistor T54 is connected to the first low-level power line VGL1.

A gate of the tenth thin film transistor T55 is connected to a control signal line Q(N−2) which transmits a control signal, a drain of the tenth thin film transistor T55 is connected to the third node R3, and a source of the tenth thin film transistor T55 is connected to the first low-level power line VGL1. A gate of the eleventh thin film transistor T56 is connected to the control signal line Q(N−2), a drain of the eleventh thin film transistor T56 is connected to the fourth node R4, and a source of the eleventh thin film transistor T56 is connected to the first low-level power line VGL1.

A gate of the twelfth thin film transistor T32 is connected to the fourth node R4, a drain of the twelfth thin film transistor T32 is connected to the second node R2, and a source of the twelfth thin film transistor T32 is connected to a second low-level power line VGL2. A gate of the thirteenth thin film transistor T42 is connected to the fourth node R4, a drain of the thirteenth thin film transistor T42 is connected to the first node R1, and a source of the thirteenth thin film transistor T42 is connected to the first low-level power line VGL1. A gate of the fourteenth thin film transistor T72 is connected to the fourth node R4, a source of the fourteenth thin film transistor T72 is connected to the first low-level power line VGL1, and a drain of the fourteenth thin film transistor T72 is connected to the Nth cascade signal line ST(N).

The second pull-down maintenance module includes the fifteenth thin film transistor T61 to the twenty-third thin film transistor T73. A gate and a drain of the fifteenth thin film transistor T61 are connected to a second low-frequency clock signal line LC2, and a source of the fifteenth thin film transistor T61 is connected to a fifth node R5. A gate of the sixteenth thin film transistor T62 is connected to the first node R1, a drain of the sixteenth thin film transistor T62 is connected to the fifth node R5, and a source of the sixteenth thin film transistor T62 is connected to the first low-level power line VGL1. A gate of the seventeenth thin film transistor T63 is connected to the fifth node R5, a drain of the seventeenth thin film transistor T63 is connected to the second low-frequency clock signal LC2, and a source of the seventeenth thin film transistor T63 is connected to a sixth node R6. A gate of the eighteenth thin film transistor T64 is connected to the first node R1, a drain of the eighteenth thin film transistor T64 is connected to the sixth node R6, and a source of the eighteenth thin film transistor T64 is connected to the first low-level power line VGL1.

A gate of the nineteenth thin film transistor T65 is connected to the control signal line Q(N−2), a drain of the nineteenth thin film transistor T65 is connected to the fifth node R5, and a source of the nineteenth thin film transistor T65 is connected to the first low-level power line VGL1. A gate of the twentieth thin film transistor T66 is connected to the control signal line Q(N−2), a drain of the twentieth thin film transistor T66 is connected to the sixth node R6, and a source of the twentieth thin film transistor T66 is connected to the first low-level power line VGL1.

A gate of the twenty-first thin film transistor T33 is connected to the sixth node R6, a drain of the twenty-first thin film transistor T33 is connected to the second node R2, and a source of the twenty-first thin film transistor T33 is connected to the second low-level power line VGL2. A gate of the twenty-second thin film transistor T43 is connected to the sixth node R6, a drain of the twenty-second thin film transistor T43 is connected to the first node R1, and a source of the twenty-second thin film transistor T43 is connected to the first low-level power line VGL1. A gate of the twenty-third thin film transistor T73 is connected to the sixth node R6, a source of the twenty-third thin film transistor T73 is connected to the first low-level power line VGL1, and a drain of the twenty-third thin film transistor T73 is connected to the Nth cascade signal line ST(N).

In some embodiments of the present application, the first spacers PS1 and the second spacers PS2 are arranged along the second direction F2. In the plan view of the liquid crystal display panel 100, the first spacers PS1 and the second spacers PS2 are each disposed between two adjacent gate driver modules GOA.

Since the first spacers PS1 and the second spacers PS2 are each disposed between two adjacent gate driver modules GOA, the risk of the first spacers PS1 and the second spacers PS2 affecting the gate driver modules GOA is reduced, and the spacers 18 provide a uniform support.

Referring to FIGS. 3 to 6, in some embodiments, each gate driver module GOA includes a first thin film transistor T21, and the first thin film transistor T21 includes the first electrode TD and the second electrode TS. The first electrode TD is connected to a corresponding scan line Scan located in the display area DA, and the second electrode TS is connected to a corresponding clock signal line CK.

In the plan view of the liquid crystal display panel 100, the plurality of gate driver modules GOA are arranged at intervals along the first direction F1, the first thin film transistors T21 are arranged at intervals along the first direction F1, and the first spacers PS1 are located outside the second electrodes TS.

It will be understood that, the first spacers PS1 are disposed outside the pattern of the second electrodes TS, which reduces or even eliminates the stress effect of the second spacers PS1 on the second insulating layer 15 and the third insulating layer 17 above the second electrodes TS, thereby reducing the risk of separation between the second insulating layer 15 and the second electrodes TS. As a result, the risk of metal precipitating from the second electrodes TS is reduced, and thus the risk of damage to the first thin film transistors T21 is reduced.

Optionally, the first electrode TD of the first thin film transistor T21 may be the drain, and the second electrode TS of the first thin film transistor T21 may be the source, which is not limited. For example, the first electrode TD of the first thin film transistor T21 may also be the source, and the second electrode TS of the first thin film transistor T21 may be the drain. The description will be given below by taking an example in which the first electrode TD of the first thin film transistor T21 is the drain and the second electrode TS of the first thin film transistor T21 is the source.

In some embodiments of the present application, in the plan view of the liquid crystal display panel 100, each of the first spacers PS1 is disposed in an adjacent area of two adjacent first thin film transistors T21 in the first direction F1.

Since each first spacer PS1 is disposed in the adjacent area of two adjacent first thin film transistors T21, the stress effect on any one of the first thin film transistors T21 caused by environmental changes is reduced, thereby reducing the risk of damage to each first thin film transistor T21. In addition, since each of the first spacers PS1 is disposed in the adjacent area of two adjacent first thin film transistors T21, the distribution of the first spacers PS1 in the entire gate driver circuit area NA1 is relatively uniform, that is, the distribution uniformity of the first spacer PS1 in the gate driver circuit area NA1 may be improved, which in turn improves the uniformity of the support on the panel.

It will be understood that, the adjacent area of two adjacent first thin film transistors T21 refer to a gap area between the two adjacent first thin film transistors T21 and output bus areas of the two first thin film transistors T21 close to the gap area.

In some embodiments of the present application, the first electrode TD includes an output bus TD1 connected to the scan line Scan and output branches TD2 connected to the output bus TD1. The second electrode TS includes an input bus TS1 connected to the clock signal line CK and input branches TS2 connected to the input bus TS1. The input bus TS1 is located at a side of the input branches TS2 away from the output bus TD1.

In the plan view of the liquid crystal display panel 100, the output branches TD2 and the input branches TS2 are arranged alternately and at intervals along the second direction F2 intersecting the first direction F1, first spacers PS1 are located outside the output branches TD2 of the two adjacent first thin film transistors, and at least a portion of each of the first spacers PS1 overlaps with the output bus TD1 of one of the two adjacent first thin film transistors.

Since the first spacers PS1 are disposed on the output bus TD1 and away from the input branches TS2 and the input bus TS1, the complex structures are avoided, reducing the risk of stress concentration in the insulating layers under the first spacers PS1, thereby reducing the risk of insulating layer separation and thus reducing the risk of the metal precipitation under the first spacers PS1.

In some embodiments, each of the first spacers PS1 may also be disposed in the gap area between two adjacent first thin film transistors T21, so that the structures under the first spacer PS1 have a flat terrain and no metal wire. As a result, the risk of damage to the first thin film transistor T21 is further reduced.

Since at least a portion of each of the first spacers PS1 overlaps with the output bus TD1, the area of the gate driver circuit area NA1 may be reduced.

In some embodiments of the present application, in the plan view of the liquid crystal display panel 100, in the adjacent area of the two adjacent first thin film transistors T21, the first spacers PS1 are located outside one of the first thin film transistors T21.

It will be understood that, since each of the first spacers PS1 is disposed in the adjacent area of two adjacent first thin film transistors T21, and the first spacer PS1 is located outside of one of the first thin film transistors T21, the stress generated by the first spacer PS1 may act on the first electrode TD of one thin film transistor T21 without affecting the first electrode TD of the other thin film transistor T21, which avoids the risk of short circuit between the two adjacent first thin film transistors T21 and further reduces the risk of damage to the first thin film transistors T21.

In addition, the first spacer PS1 does not span across two thin film transistors, making the structures under the first spacer PS1 simpler and flatter, which may reduce the risk of stress concentration in the insulating layers.

In some embodiments of the present application, each first thin film transistor T21 further includes a gate TG. The gate TG also serves as a first electrode plate of the capacitor, and the output bus TD1 also serves as a second electrode plate of the capacitor, and the gate TG overlaps with the output bus TD1 to form the capacitor C1.

In the plan view of the liquid crystal display panel 100, the first spacer PS1 entirely overlaps with a corresponding capacitor C1.

It will be understood that, the area of the capacitor C1 has a flat terrain, and thus the first spacer PS1 is disposed in the area where the capacitor C1 is located, which may reduce the risk of stress concentration in the insulating layers under the first spacers PS1, thereby reducing the risk of insulating layer separation and thus reducing the risk of metal precipitation.

In some embodiments of the present application, the clock signal line CK includes a clock signal main line K01 and clock signal branches K02 connected to the clock signal main line K01. The clock signal main line K01 is located in the peripheral area NA2. Each of the clock signal branches K02 extends from the peripheral area NA2 to the gate driver circuit area NA1 and is connected to the second electrode of one first thin film transistor T21. The array substrate 10 further includes a plurality of second spacers PS2 located at a side of the first spacers PS1 away from the display area DA.

In the plan view of the liquid crystal display panel 100, the plurality of second spacers PS2 are located at a side of the clock signal main line K01 close to the display area DA and outside the clock signal branches K02.

It will be noted that, in a case where the spacer(s) 18 stand above a metal wire, and when stress is generated in the spacer(s) 18, the stress will cause the wire under the spacer(s) 18 to deform, and further affect the load on the wire. Therefore, the second spacers PS2 are disposed outside the clock signal line CK, the load on the clock signal line CK is not affected by the second spacers PS2, maintaining the uniformity of the load on the clock signal line CK and thereby reducing the risk of horizontal lines being produced.

In some embodiments of the present application, in the first direction F1, a width R1 of each of the clock signal branches K02 is less than a width R2 of any one of the second spacers PS2.

It will be understood that, the clock signal branches K02 each have a relatively small width R1, which not only saves space but also reduces the risk of the second spacers PS2 mistakenly standing on the clock signal branches K02.

Optionally, the width R1 of each clock signal branch K02 is less than a width of the second auxiliary spacer S02, which further reduces the risk of the second spacers PS2 mistakenly standing on the clock signal branches K02.

In some embodiments of the present application, the gate driver modules GOA each further include the second thin film transistor T22 to the twenty-third thin film transistor T73. In the plan view of the liquid crystal display panel 100, the second spacers PS2 are located outside the second thin film transistors T22 to the twenty-third thin film transistors T73.

It will be understood that, the second spacers PS2 are disposed outside the range of all thin film transistors of the gate driver modules GOA, which reduces the risk of any one of the thin film transistors being damaged.

In some embodiments of the present application, the liquid crystal display panel 100 further includes the adhesive frame 30 disposed between the array substrate 10 and the counter substrate 20, with the adhesive frame 30 correspondingly disposed in the peripheral area NA2. The adhesive frame 30 is located at the side of the clock signal main line K01 away from the display area DA.

A distance L1 between one of the second spacers PS2 closest to the adhesive frame 30 in the second direction F2 and the adhesive frame 30 is less than 2700 micrometers.

It will be understood that, the less the distance L1 from the second spacer PS2 to the adhesive frame 30, the bigger the range supported by the second spacers PS2, and the lower the risk of damage to the array substrate 10 and the counter substrate 20 due to the narrowing of the gap between the array substrate 10 and the counter substrate 20 in the non-display area NA under the action of an external force. Therefore, the distance L1 is set to be less than 2700 micrometers, which reduces the risk of damage to the array substrate 10 and the counter substrate 20.

Optionally, the distance L1 from the second spacer PS2 to the adhesive frame 30 may be 2600 micrometers, 2500 micrometers, 2400 micrometers, 2300 micrometers, 2200 micrometers, 2100 micrometers, 2000 micrometers, 1900 micrometers, 1800 micrometers, 1700 micrometers, 1600 micrometers, 1500 micrometers, 1400 micrometers, 1300 micrometers, 1200 micrometers, 1100 micrometers, 1000 micrometers, 900 micrometers, 800 micrometers, 700 micrometers, 600 micrometers, 500 micrometers, or the like.

Optionally, the distance L1 between the adhesive frame 30 and the second spacer PS2 closest to the adhesive frame is less than or equal to 1800 micrometers, which not only reduces the risk of damage to the array substrate 10 and the counter substrate 20, but also evenly provides the second spacers PS2 in the second direction F2 in the entire gate driver circuit area NA1, enhancing the support strength for the gate driver circuit area NA1.

In some embodiments of the present application, the array substrate 10 further includes a low-frequency clock signal line LC and a first low-level power line VGL1, with the low-frequency clock signal line LC and the first low-level power line VGL1 located in the peripheral area NA2. The first low-level power line VGL1 is located at a side of the low-frequency clock signal line LC away from the clock signal main line K01.

In the plan view of the liquid crystal display panel 100, the second spacers PS2 are located at the side of the low-frequency clock signal line LC away from the clock signal line CK.

The second spacers PS2 are arranged in rows along the second direction F2, and part of the second spacers PS2 in one row overlaps with the first low-level power line VGL1.

It will be understood that, the second spacers PS2 are disposed in the peripheral area NA2, which causes the second spacers PS2 closer to the adhesive frame 30, increasing the range of support by the spacers 18, thereby reducing the risk of damage to the array substrate 10 and the counter substrate 20 due to the narrowing of the gap between the array substrate 10 and the counter substrate 20 in the non-display area NA under the action of an external force.

In some embodiments, one or two of the second spacers PS2 may stand on the low-frequency clock signal line LC to further shorten the distance L1 between the second spacers PS2 and the adhesive frame 30.

Optionally, the common electrode line Acom is disposed in the peripheral area NA2 and overlaps with the adhesive frame 30 to reduce the size of the array substrate 10.

In the liquid crystal display panel of the present application, since the first spacers are disposed outside the second electrodes of the first thin film transistors, the effect of the stress of the first spacers on film layers in the area where the second electrodes are located is reduced, thereby reducing the risk of metal precipitating from the second electrodes, and thus reducing the risk of damage to the first thin film transistors.

The liquid crystal display panel provided in the embodiments of the present application is described in details above. Specific examples have been used in the context to illustrate the principles and implementations of the present application, and the description of the embodiments is only for the purpose of helping to understand the method and core ideas of the present application. In addition, for those skilled in the art, there will be changes in the specific implementations and the scope of application based on the ideas of the present application. In summary, the content of the description should not be understood as limiting the present application.

What is claimed is:

1. A liquid crystal display panel, comprising an array substrate and a counter substrate that are arranged opposite to each other, wherein the liquid crystal display panel has a display area and a gate driver circuit area, the gate driver circuit area is located at at least one side of the display area, and the array substrate comprises:
a plurality of gate driver modules that are cascaded in the gate driver circuit area, wherein the gate driver modules each comprise a first thin film transistor comprising a first electrodes and a second electrode, the first electrode is connected to a scan line located in the display area, and the second electrode is connected to a clock signal line; and
a plurality of first spacers disposed in the gate driver circuit area;
wherein in a plan view of the liquid crystal display panel, the plurality of gate driver modules are arranged at intervals along a first direction, all the first thin film transistors are arranged at intervals along the first direction, and the first spacers are located outside all the second electrodes.

2. The liquid crystal display panel according to claim 1, in the plan view of the liquid crystal display panel, each of the first spacers is disposed in an adjacent area of two adjacent ones of the first thin film transistors in the first direction.

3. The liquid crystal display panel according to claim 2, wherein the first electrode comprises an output bus connected to the scan line and output branches connected to the output bus, and the second electrode comprises an input bus connected to the clock signal line and input branches connected to the input bus; and
in the plan view of the liquid crystal display panel, the output branches and the input branches are alternately arranged at intervals along a second direction intersecting the first direction, the first spacer is located outside all the output branches of the two adjacent first thin film transistors, at least a portion of the first spacer overlaps with the output bus of one of the two adjacent first thin film transistors.

4. The liquid crystal display panel according to claim 3, wherein in the plan view of the liquid crystal display panel, in the adjacent area of the two adjacent first thin film transistors, the first spacer is located outside the other of the two adjacent first thin film transistors.

5. The liquid crystal display panel according to claim 3, wherein the one of the two adjacent first thin film transistors further comprises a gate, the gate also serves as a first electrode plate of a capacitor, the output bus also serves as a second electrode plate of the capacitor, and the gate overlaps with the output bus to form the capacitor; and
in the plan view of the liquid crystal display panel, the first spacer entirely overlaps with the capacitor.

6. The liquid crystal display panel according to claim 2, wherein the liquid crystal display panel comprises a peripheral area located at a side of the gate driver circuit area away from the display area, the clock signal line comprises a clock signal main line and clock signal branches connected to the clock signal main line, the clock signal main line is located in the peripheral area, each of the clock signal branches extends from the peripheral area to the gate driver circuit area and is connected to the second electrode of the first thin film transistor of a corresponding one of the gate driver modules, the array substrate further comprises a plurality of second spacers located at a side of the first spacers away from the display area; and
in the plan view of the liquid crystal display panel, the plurality of second spacers are located at a side of the clock signal main line close to the display area and outside the clock signal branches.

7. The liquid crystal display panel according to claim 6, wherein along the first direction, a width of each of the clock signal branches is less than a width of each of the plurality of second spacers.

8. The liquid crystal display panel according to claim 6, wherein the gate driver module further comprises a second thin film transistor to a twenty-third thin film transistor, and in the plan view of the liquid crystal display panel, the plurality of second spacers are located outside the second thin film transistor to the twenty-third thin film transistor.

9. The liquid crystal display panel according to claim 8, wherein the array substrate further comprises a low-frequency clock signal line and a first low-level power line that are located in the peripheral area, the first low-level power line is located at a side of the low-frequency clock signal line away from the clock signal main line;
in the plan view of the liquid crystal display panel, the plurality of second spacers are located at the side of the low-frequency clock signal line away from the clock signal line; and
the plurality of second spacers are arranged in rows along the second direction, and part of the second spacers in one of the rows overlaps with the first low-level power line.

10. The liquid crystal display panel according to claim 6, wherein the array substrate comprises: a first base, a first metal layer, a first insulating layer, a second metal layer, a second insulating layer, a color resist layer, and a third insulating layer that are arranged in sequence, the color resist layer is disposed in the display area, the first spacers and the second spacers are disposed on a side of the third insulating layer away from the first base; and
the second metal layer comprises a plurality of wires arranged at intervals, and each of the second spacers overlaps with at most one of the wires.

11. The liquid crystal display panel according to claim 6, wherein the liquid crystal display panel further comprises an adhesive frame disposed between the array substrate and the counter substrate, the adhesive frame is correspondingly disposed in the peripheral area, and the adhesive frame is located at a side of the clock signal main line away from the display area; and
a distance between one of the second spacers closest to the adhesive frame in the second direction and the adhesive frame is less than 2700 micrometers.

12. The liquid crystal display panel according to claim 10, wherein the first spacers and the second spacers are arranged along the second direction, and in the plan view of the liquid crystal display panel, the first spacers and the second spacers are each disposed between two adjacent ones of the gate driver modules.

13. The liquid crystal display panel according to claim 12, wherein the array substrate further comprises third spacers disposed in the display area, the second spacers, the first spacers, and the third spacers are arranged along the second direction.

14. The liquid crystal display panel according to claim 7, wherein the array substrate comprises: a first base, a first metal layer, a first insulating layer, a second metal layer, a second insulating layer, a color resist layer, and a third insulating layer that are arranged in sequence, the color resist layer is disposed in the display area, the first spacers and the second spacers are disposed on a side of the third insulating layer away from the first base; and
the second metal layer comprises a plurality of wires arranged at intervals, and each of the second spacers overlaps with at most one of the wires.

15. The liquid crystal display panel according to claim 8, wherein the array substrate comprises: a first base, a first metal layer, a first insulating layer, a second metal layer, a second insulating layer, a color resist layer, and a third insulating layer that are arranged in sequence, the color resist layer is disposed in the display area, the first spacers and the second spacers are disposed on a side of the third insulating layer away from the first base; and
the second metal layer comprises a plurality of wires arranged at intervals, and each of the second spacers overlaps with at most one of the wires.

16. The liquid crystal display panel according to claim 9, wherein the array substrate comprises: a first base, a first metal layer, a first insulating layer, a second metal layer, a second insulating layer, a color resist layer, and a third insulating layer that are arranged in sequence, the color resist layer is disposed in the display area, the first spacers and the second spacers are disposed on a side of the third insulating layer away from the first base; and
the second metal layer comprises a plurality of wires arranged at intervals, and each of the second spacers overlaps with at most one of the wires.

17. The liquid crystal display panel according to claim 14, wherein the first spacers and the second spacers are arranged along the second direction, and in the plan view of the liquid crystal display panel, the first spacers and the second spacers are each disposed between two adjacent ones of the gate driver modules.

18. The liquid crystal display panel according to claim 17, wherein the array substrate further comprises third spacers disposed in the display area, the second spacers, the first spacers, and the third spacers are arranged along the second direction.

19. The liquid crystal display panel according to claim 7, wherein the liquid crystal display panel further comprises an adhesive frame disposed between the array substrate and the counter substrate, the adhesive frame is correspondingly disposed in the peripheral area, and the adhesive frame is located at a side of the clock signal main line away from the display area; and
a distance between one of the second spacers closest to the adhesive frame in the second direction and the adhesive frame is less than 2700 micrometers.

20. The liquid crystal display panel according to claim 8, wherein the liquid crystal display panel further comprises an adhesive frame disposed between the array substrate and the counter substrate, the adhesive frame is correspondingly disposed in the peripheral area, and the adhesive frame is located at a side of the clock signal main line away from the display area; and
a distance between one of the second spacers closest to the adhesive frame in the second direction and the adhesive frame is less than 2700 micrometers.
